(19) United States
(12) Patent Application Publication
(10) Pub. No.: US 2022/0300868 A1
(43) Pub. Date: Sep. 22, 2022

(54) OPERATING RESERVE QUANTIFICATION METHOD FOR POWER SYSTEMS USING PROBABILISTIC WIND POWER FORECASTING

(71) Applicant: ZHEJIANG UNIVERSITY, Hangzhou (CN)

(72) Inventors: Can Wan, Hangzhou (CN); Changfei Zhao, Hangzhou (CN); Yonghua Song, Hangzhou (CN)

(21) Appl. No.: 17/718,326

(22) Filed: Apr. 12, 2022

Related U.S. Application Data
(63) Continuation of application No. PCT/CN2021/080896, filed on Mar. 16, 2021.

(51) Int. Cl. G06Q 10/04; G06Q 50/06; G06F 17/12; G06N 20/00

(52) U.S. Cl. CPC G06Q 10/04; G06Q 50/06; G06F 17/12; G06N 20/00

(57) ABSTRACT

The present invention discloses an operating reserve quantification method for power systems using probabilistic wind power forecasting and belongs to the field of power system operation optimization. This method constructs an operating reserve optimization model of power systems using probabilistic wind power forecasting, which utilizes extreme learning machine to output non-parametric prediction intervals of wind power and determines the positive and negative operating reserve requirements of the system by upper and lower boundaries of the prediction intervals. The cost-benefit trade-offs of reserve decision are realized by taking reserve provision cost and deficit penalty as a loss function of machine learning. The resultant reserve decision can effectively reduce system operation cost on the premise of ensuring good reliability. The present invention transforms complicated machine learning model into a mixed integer linear programming problem, which can be efficiently solved after implementing a feasible region tightening method.

### TECHNICAL FIELD

The present invention relates to an operating reserve quantification method for power systems using probabilistic wind power forecasting, and belongs to the field of power operation optimization.

### BACKGROUND

At present, a large scale of intermittent power sources represented by wind power are integrated into the power systems. Compared with traditional thermal power units, the intermittent power sources are significantly affected by meteorological factors, and its power generation cannot be accurately predicted and effectively adjusted, which presents significant uncertainty and uncontrollability and brings severe challenges to the real-time energy balance of power systems. Adequate operating reserves of the power system can effectively compensate for power imbalance caused by prediction error of the intermittent power source, which are of great significance to maintain the balance of supply and demand in power systems and ensure the secure and stable operations of the power grid.

Traditionally, in order to prevent the imbalance of supply and demand caused by failures of important power sources or lines, the operating reserves of the power system are generally determined according to the maximum unit capacity or load level of the system. Compared with these large-scale failures, wind power output deviations continuously occur in normal operations of power systems. Traditional deterministic approaches for quantifying reserves are difficult to adapt to the modern power systems with high penetration of wind power. At present, the development of probabilistic forecasting technology has made the uncertainty quantification of wind power prediction possible, so that power system operators can use probabilistic wind power forecasting to quantify the operating reserves, and achieve the optimal trade-off between guarantee of system reliability and operational cost reduction.

### SUMMARY

Given the limitations of the related background technology, the present invention proposes an operating reserve quantification method for power systems using probabilistic wind power forecasting. This method utilizes extreme learning machine to output non-parametric prediction intervals of wind power, and determines the positive and negative operating reserve requirements by upper and lower boundaries of the prediction intervals. The cost-benefit trade-offs of reserve decision are realized by taking reserve provision cost and deficit penalty as a loss function of machine learning .The resultant reserve decision can effectively reduce system operation cost on the premise of ensuring good reliability.

In order to achieve the object above, the present invention adopts the following technical solutions.

(1) Construct an operating reserve optimization model using probabilistic wind power forecasting

A lowest confidence of the prediction intervals with respect to training samples is restricted by an inequation constraint, and the prediction intervals of wind power are output directly by the extreme learning machine without specifying confidence level and boundary quantile proportions of the prediction intervals in advance. The capacity requirement of positive and negative operating reserves is determined based on boundaries of the prediction intervals, and by taking reserve provision cost and deficit penalty as a loss function, an operating reserve optimization model using probabilistic wind power forecasting is constructed:

$${min}_{\begin{matrix}{ω}_{\underline{α}} , {ω}_{\overline{α}} , \\ {r}_{t}^{u} , {r}_{t}^{d} , \\ {r}_{t , -}^{u} , {r}_{t , -}^{d}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ ( {‖ {ω}_{\underline{α}} ‖}_{1} + {‖ {ω}_{\overline{α}} ‖}_{1} )$$

which is subject to:

$$\frac{1}{𝒯} {\sum }_{t ∈ 𝒯} 𝕀 ( q ( {x}_{t} ; {ω}_{\underline{α}} ) \leq {\overline{w}}_{t} \leq q ( {x}_{t} ; {ω}_{\overline{α}} ) ) \geq 1 - ϵ$$

$$0 \leq ( q ( {x}_{t} ; {ω}_{\underline{α}} ) \leq q ( {x}_{t} ; {ω}_{\overline{α}} ) \leq {w}_{c} , ∀ t ∈ 𝒯$$

$${r}_{t}^{u} = max \{ {\hat{w}}_{t} - q ( {x}_{t} ; {ω}_{\underline{α}} ) , 0 \} , ∀ t ∈ 𝒯$$

$${r}_{t}^{d} = max \{ q ( {x}_{t} ; {ω}_{\overline{α}} ) - {\hat{w}}_{t} , 0 \} , ∀ t ∈ 𝒯$$

$${r}_{t , -}^{u} = max \{ {\hat{w}}_{t} - {\overline{w}}_{t} - {r}_{t}^{u} , 0 \} , ∀ t ∈ 𝒯$$

$${r}_{t , -}^{d} = max \{ {\overline{w}}_{t} - {\hat{w}}_{t} - {r}_{t}^{d} , 0 \} , ∀ t ∈ 𝒯$$

in which, t is a time index, [symbol] is a time index set of the training samples; ω_{α} and ω_{α̅} are weight vectors corresponding to two output neurons in the extreme learning machine; rₜ^{u} and rₜ^{d} are positive and negative reserve capacities respectively; r_{t,—}^{u} and r_{t,—}^{d} are positive and negative reserve deficits respectively; π^{u} and π^{d} are prices for the positive and negative reserve provision payments respectively; π_^{u} and π_^{d} are prices for the positive and negative reserve deficit penalties respectively; λ is a weight parameter of the L1 regular term (∥ω_{α}∥₁+∥ω_{α̅}∥₁), whose value trade-offs between the goodness-of-fit and model complexity; w̅ₜ is real wind power; ŵₜ is expected wind power; w_{c} is the total quantity of wind power installations of the system; q(xₜ;ω_{α̅}) and q(xₜ;ω_{α}) are upper and lower boundaries of the prediction interval output by the extreme learning machine; xₜ is an input feature vector of the machine learning model; 1−ϵ is a lowest confidence level of the prediction interval, which corresponds to reliability requirement of operating reserve of the power system; [symbol] (•) is an indicator function, and a function value is 1 when a logical expression in the parentheses is established, otherwise the function value is 0; max(•) is a maximum value function, which returns a largest operand.

(2) Construct an operating reserve optimization model of the power system using probabilistic wind power forecasting, which is formulated as a mixed integer linear programming problem

The non-smooth L1 regular term in the loss function is linearized by introducing auxiliary continuous vectors, the indicator function and the maximum value function in constraints is linearized by introducing auxiliary logical variables, and an operating reserve quantification model using probabilistic wind power forecasting is equivalently transformed into the mixed integer linear programming problem:

$${min}_{\begin{matrix}{ω}_{\underline{α}} , {ω}_{\overline{α}} , {η}_{\underline{α}} , {η}_{\overline{α} ,} \\ {r}_{t}^{u} , {r}_{t}^{d} , {r}_{t , -}^{u} , {r}_{t , -}^{d} , \\ {z}_{t}^{\underline{α}} , {z}_{t}^{\overline{α}} , {z}_{t} , {z}_{t}^{u} , {z}_{t}^{d}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ {\vec{1}}^{T} ( {η}_{\underline{α}} + {η}_{\overline{α}} )$$

which is subject to:

$${\overline{w}}_{t} - {\overline{w}}_{t} {z}_{t}^{\underline{α}} \leq q ( {x}_{t} ; {ω}_{\underline{α}} ) \leq {\overline{w}}_{t} + {M}_{t}^{\underline{α}} ( 1 - {z}_{t}^{\underline{α}} ) , ∀ t ∈ 𝒯$$

$${\overline{w}}_{t} - {M}_{t}^{\overline{α}} ( 1 - {z}_{t}^{\overline{α}} ) \leq q ( {x}_{t} ; {ω}_{\overline{α}} ) \leq {\overline{w}}_{t} + ( {w}_{c} - {\overline{w}}_{t} ) {z}_{t}^{\overline{α}} , ∀ t ∈ 𝒯$$

$${z}_{t}^{\underline{α}} + {z}_{t}^{\overline{α}} - 1 \leq {z}_{t} \leq min \{ {z}_{t}^{\underline{α}} , {z}_{t}^{\overline{α}} \} , ∀ t ∈ 𝒯$$

$${\sum }_{t ∈ 𝒯} ( 1 - {z}_{t} ) \leq ϵ \vert 𝒯 \vert$$

$$0 \leq q ( {x}_{t} ; {ω}_{\underline{α}} ) \leq q ( {x}_{t} ; {ω}_{\overline{α}} ) \leq {w}_{c} , ∀ t ∈ 𝒯$$

$$0 \leq {r}_{t}^{u} - [ {\hat{w}}_{t} - q ( {x}_{t} ; {ω}_{\underline{α}} ) ] \leq {M}_{t}^{u} ( 1 - {z}_{t}^{u} ) , ∀ t ∈ 𝒯$$

$$0 \leq {r}_{t}^{u} \leq {\hat{w}}_{t} {z}_{t}^{u} , ∀ t ∈ 𝒯$$

$$0 \leq {r}_{t}^{d} - [ q ( {x}_{t} ; {ω}_{\overline{α}} ) - {\hat{w}}_{t} ] \leq {M}_{t}^{d} ( 1 - {z}_{t}^{d} ) , ∀ t ∈ 𝒯$$

$$0 \leq {r}_{t}^{d} \leq ( {w}_{c} - {\hat{w}}_{t} ) {z}_{t}^{d} , ∀ t ∈ 𝒯$$

$${z}_{t}^{\underline{α}} , {z}_{t}^{\overline{α}} , {z}_{t} , {z}_{t}^{u} , {z}_{t}^{d} ∈ \{ 0 , 1 \} , ∀ t ∈ 𝒯$$

$${r}_{t , -}^{u} \geq {\hat{w}}_{t} - {\overline{w}}_{t} - {r}_{t}^{u} , ∀ t ∈ 𝒯$$

$${r}_{t , -}^{d} \geq {\overline{w}}_{t} - {\hat{w}}_{t} - {r}_{t}^{d} , ∀ t ∈ 𝒯$$

$${r}_{t , -}^{u} , {r}_{t , -}^{d} \geq 0 , ∀ t ∈ 𝒯$$

$${η}_{α} \geq {ω}_{α} , {η}_{α} \geq - {ω}_{α} , ∀ α ∈ \{ \underline{α} , \overline{α} \}$$

in which, \vec{1} is a vector whose elements are all 1; η_{α} and η_{α̅} are introduced auxiliary vectors equal to the elementwise absolute value of ω_{α} and ω_{α̅} at the optimum of above optimization problem; zₜ^{α},zₜ^{α̅},zₜ,zₜ^{u},zₜ^{d} are introduced auxiliary logical variables, wherein zₜ^{α},zₜ^{α̅},zₜ linearize the inequality constraint including indicator function, zₜ^{u},zₜ^{d} linearize the equality constraints including the maximum value function; Mₜ^{α}, Mₜ^{α̅}, Mₜ^{u},Mₜ^{d} are referred to as the big-M coefficients, specifically, Mₜ^{α} is a constant coefficient larger than q(xₜ;ω_{α})−w̅_{c}, Mₜ^{α̅} is a constant coefficient larger than w̅ₜ−q(xₜ;ω_{α̅}), Mₜ^{u} is a constant coefficient larger than q(xₜ;ω_{α})−ŵₜ, and Mₜ^{d} is a constant coefficient larger than ŵₜ−q(xₜ;ω_{α̅}).

(3) Estimate value ranges of upper and lower boundaries of the prediction intervals

The quantile regression technique is utilized to obtain predictive quantiles \hat{q}ₜ^{ϵ} and \hat{q}ₜ^{1-ϵ} with ϵ and 1−ϵ quantile proportions of the real wind power w̅ₜ in training dataset, and the infimum inf{q(xₜ;ω_{α̅})} of the upper boundary of the prediction interval and supremum sup{q(xₜ;ω_{α})} of the lower boundary of the prediction interval are approximated according to the following formulas:

sup{q(xₜ;ω_{α})}≈\hat{q}ₜ^{ϵ}, ∀t∈

[symbol]

inf{q(xₜ;ω_{α̅})}≈\hat{q}ₜ^{1-ϵ}, ∀t∈

[symbol]

in which sup{•} and inf{•} are operators of supremum and infimum respectively.

(4) Shrink the big-M coefficients in the mixed integer linear programming problem

The big-M coefficients in the mixed integer linear programming problem are shrunk according to the following formulas:

Mₜ^{α}=sup{q(xₜ;ω_{α})}−w̅ₜ≈\hat{q}ₜ^{ϵ}−w̅ₜ, ∀t∈

[symbol]

Mₜ^{α̅}=w̅ₜ−inf{q(xₜ;ω_{α̅})}≈w̅ₜ−\hat{q}ₜ^{1-ϵ}, ∀t∈

[symbol]

Mₜ^{u}=sup{q(xₜ;ω_{α})}−ŵₜ≈\hat{q}ₜ^{ϵ}−ŵₜ, ∀t∈

[symbol]

Mₜ^{u}=ŵₜ−inf{q(xₜ;ω_{α̅})}≈ŵₜ−\hat{q}ₜ^{1-ϵ}, ∀t∈

[symbol]

in which, \hat{q}ₜ^{ϵ} and \hat{q}ₜ^{1-ϵ} indicate quantile estimation of the wind power w̅ₜ at quantile proportions ϵ and 1−ϵ respectively.

(5) Eliminate the auxiliary logical variables in the mixed integer linear programming problem

A time index set [symbol] is defined to contain time indexes corresponding to all the real wind power w̅ₜ covered by the interval [\hat{q}ₜ^{ϵ},\hat{q}ₜ^{1-ϵ}] in the training dataset, namely

[symbol]

:={t∈ [symbol] |\hat{q}ₜ^{ϵ}≤w̅ₜ≤\hat{q}ₛ^{1-ϵ}}.

A time index set [symbol] is defined to contain time indexes corresponding to all the expected wind power values ŵₜ greater than or equal to \hat{q}ₜ^{ϵ} in the training dataset, namely

[symbol]

:={t∈ [symbol] |ŵₜ−\hat{q}ₜ^{ϵ}≥0}.

A time index set [symbol] is defined to contain time indexes corresponding to all the expected wind power values ŵₜ less than or equal to \hat{q}ₜ^{1-ϵ} in the training dataset, namely

[symbol]

:={t∈ [symbol] |\hat{q}ₜ^{1-ϵ}−ŵₜ≥0}.

The logical variables zₜ,zₜ^{u},zₜ^{d} whose time indexes in the sets [symbol] , [symbol] , [symbol] respectively, certainly have values of 1, and can be preset before solving optimization problem in advance, thereby achieving reduction of auxiliary logical variables:

zₜ^{α}=zₜ^{α̅}=zₜ=1, ∀t∈

[symbol]

zₜ^{u}=1, ∀t∈

[symbol]

zₜ^{d}=1, ∀t∈ [symbol] .

(6) Obtain a reduced mixed integer linear programming problem by executing a feasible region tightening strategy

A feasible region tightening of the mixed integer linear programming problem is achieved by executing the shrinkage of big-M coefficients and the elimination of auxiliary logical variables, so as to obtain a reduced mixed integer linear programming problem:

$${min}_{\begin{matrix}{ω}_{\underline{α}} , {ω}_{\overline{α}} , {η}_{\underline{α}} , {η}_{\overline{α} ,} \\ {r}_{t}^{u} , {r}_{t}^{d} , {r}_{t , -}^{u} , {r}_{t , -}^{d} , \\ {z}_{t}^{\underline{α}} , {z}_{t}^{\overline{α}} , {z}_{t} , {z}_{t}^{u} , {z}_{t}^{d}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ {\vec{1}}^{T} ( {η}_{\underline{α}} + {η}_{\overline{α}} )$$

which is subject to:

$$q ( {x}_{t} ; {ω}_{\underline{α}} ) \leq {\overline{w}}_{t} \leq q ( {x}_{t} ; {ω}_{\overline{α}} ) , ∀ t ∈ 𝒮$$

$${\overline{w}}_{t} - {\overline{w}}_{t} {z}_{t}^{\underline{α}} \leq q ( {x}_{t} ; {ω}_{\underline{α}} ) \leq {\overline{w}}_{t} + ( {\hat{q}}_{t}^{ϵ} - {\overline{w}}_{t} ) ( 1 - {z}_{t}^{\underline{α}} ) , ∀ t ∈ 𝒯 \backslash 𝒮$$

$${\overline{w}}_{t} - ( {\overline{w}}_{t} - {\hat{q}}_{t}^{1 - ϵ} ) ( 1 - {z}_{t}^{\overline{α}} ) \leq q ( {x}_{t} , {ω}_{\overline{α}} ) \leq {\overline{w}}_{t} + ( {w}_{c} - {\overline{w}}_{t} ) {z}_{t}^{\overline{α}} , ∀ t ∈ 𝒯 \backslash 𝒮$$

$${z}_{t}^{\underline{α}} + {z}_{t}^{\overline{α}} - 1 \leq {z}_{t} \leq min \{ {z}_{t}^{\underline{α}} , {z}_{t}^{\overline{α}} \} , ∀ t ∈ 𝒯 \backslash 𝒮$$

$${\sum }_{t ∈ 𝒯 \backslash 𝒮} ( 1 - {z}_{t} ) \leq ϵ \vert 𝒯 \vert$$

$$0 \leq q ( {x}_{t} ; {ω}_{\underline{α}} ) \leq q ( {x}_{t} ; {ω}_{\overline{α}} ) \leq {w}_{c} , ∀ t ∈ 𝒯$$

$${r}_{t}^{u} = {\hat{w}}_{t} - q ( {x}_{t} ; {ω}_{\underline{α}} ) , ∀ t ∈ ℒ$$

$${r}_{t}^{d} = q ( {x}_{t} ; {ω}_{\overline{α}} ) - {\hat{w}}_{t} , ∀ t ∈ 𝒰$$

$$0 \leq {r}_{t}^{u} - [ {\hat{w}}_{t} - q ( {x}_{t} ; {ω}_{\underline{α}} ) ] \leq {M}_{t}^{u} ( 1 - {z}_{t}^{u} ) , ∀ t ∈ 𝒯 \backslash ℒ$$

$$0 \leq {r}_{t}^{u} \leq {\hat{w}}_{t} {z}_{t}^{u} , ∀ t ∈ 𝒯 \backslash ℒ$$

$$0 \leq {r}_{t}^{d} - [ q ( {x}_{t} ; {ω}_{\overline{α}} ) - {\hat{w}}_{t} ] \leq {M}_{t}^{d} ( 1 - {z}_{t}^{d} ) , ∀ t ∈ 𝒯 \backslash 𝒰$$

$$0 \leq {r}_{t}^{d} \leq ( {w}_{c} - {\hat{w}}_{t} ) {z}_{t}^{d} , ∀ t ∈ 𝒯 \backslash 𝒰$$

$${z}_{t}^{\underline{α}} , {z}_{t}^{\overline{α}} , {z}_{t} , {z}_{t}^{u} , {z}_{t}^{d} ∈ \{ 0 , 1 \} , ∀ t$$

$${r}_{t , -}^{u} \geq {\hat{w}}_{t} - {\overline{w}}_{t} - r - tu , ∀ t ∈ 𝒯$$

$${r}_{t , -}^{d} \geq {\overline{w}}_{t} - {\hat{w}}_{t} - {r}_{t}^{d} , ∀ t ∈ 𝒯$$

$${r}_{t , -}^{u} , {r}_{t , -}^{d} \geq 0 , ∀ t ∈ 𝒯$$

$${η}_{α} \geq {ω}_{α} , {η}_{α} \geq - {ω}_{α} , ∀ α ∈ \{ \underline{α} , \overline{α} \}$$

in which, \ is a difference set symbol. Compared with the mixed integer linear programming problem, there are 3| [symbol] |+| [symbol] |+| [symbol] | integer variables in total to be reduced, which greatly reduces problem scale.

(7) Solve the reduced mixed integer linear programming problem

Branch and bound algorithm is utilized to solve the reduced mixed integer linear programming model, output weight vectors of the extreme learning machine are obtained, and training of the extreme learning machine is completed.

The beneficial results of the present invention are as follows.

The present invention constructs the wind power prediction intervals based on extreme learning machine, which does not need to impose priori assumptions on probability distribution of prediction uncertainty and optimizes the value of prediction information for decision with the goal of minimizing the backup cost. The present invention proposes an operating reserve optimization method using probabilistic wind power forecasting, which balances the cost-benefit brought by the reserve provision on the premise of well reliability requirement. The proposed reserve quantification method helps to maintain energy balance, and facilitates the secure and stable operations of the power systems with a high proportion of wind power penetration. In order to establish the reserve quantification model, a feasible region tightening strategy based on the shrinkage of big-M coefficients and the reduction of auxiliary logical variables is proposed, which transforms the original model into a moderate-scale mixed integer linear programming problem, thereby achieving efficient computational performance and reliably supporting online application of the method.

### BRIEF DESCRIPTION OF THE DRAWINGS

FIG. 1 is a flowchart of an operating reserve quantification method for power systems using probabilistic wind power forecasting according to the present invention; and

FIG. 2 is a graph demonstrating the relationship between probabilistic wind power forecasting and requirement of positive and negative operating reserves.

### DETAILED DESCRIPTION

The present invention will be further described below with reference to the accompanying drawings and embodiments.

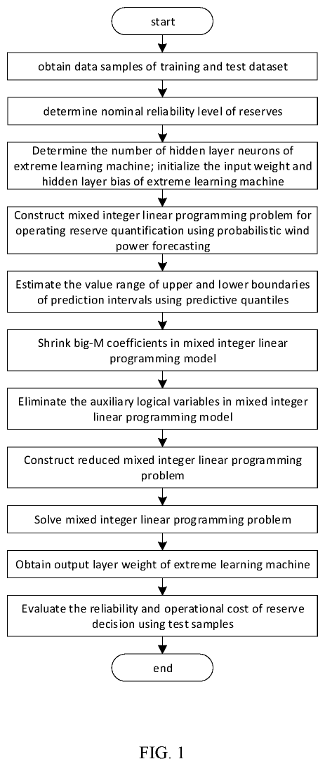

The flowchart of the operating reserve quantification method for power systems using probabilistic wind power forecasting proposed by the present invention is shown in FIG. 1.

(1) Obtain a training dataset [symbol] := [symbol] and a test dataset [symbol] ={xₜ,w̅ₜ},_{t∈ϵ}, where xₜ is an input feature vector of a machine learning model, such as historical wind power, wind speed and direction, etc., and w̅ₜ is the real wind power; obtain the expected wind power generation [symbol] corresponding to samples in the training dataset and the test dataset; obtain the total quantity w_{c} of wind power installations of the studied system; and determine the nominal reliability level 100(1−ϵ)% of operating reserve according to operational regulations of the power system.

(2) Determine the number of the hidden layer neurons of extreme learning machine, initialize input weight vectors and hidden layer bias of the extreme learning machine, and obtain basic formulations of output functions q(xₜ;ω_{α}) and q(xₜ;ω_{α̅}) of the extreme learning machine, wherein the output weight vectors ωₐ and ω_{α̅} are variables to be optimized.

(3) Construct a mixed integer linear programming problem for operating reserve quantification using probabilistic wind power forecasting:

$${min}_{\begin{matrix}{ω}_{\underline{α}} , {ω}_{\overline{α}} , {η}_{\underline{α}} , {η}_{\overline{α} ,} \\ {r}_{t}^{u} , {r}_{t}^{d} , {r}_{t , -}^{u} , {r}_{t , -}^{d} , \\ {z}_{t}^{\underline{α}} , {z}_{t}^{\overline{α}} , {z}_{t} , {z}_{t}^{u} , {z}_{t}^{d}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ {\vec{1}}^{T} ( {η}_{\underline{α}} + {η}_{\overline{α}} )$$

which is subject to:

$${\overline{w}}_{t} - {\overline{w}}_{t} {z}_{t}^{\underline{α}} \leq q ( {x}_{t} ; {ω}_{\underline{α}} ) \leq {\overline{w}}_{t} + {M}_{t}^{\underline{α}} ( 1 - {z}_{t}^{\underline{α}} ) , ∀ t ∈ 𝒯$$

$${\overline{w}}_{t} - {M}_{t}^{\overline{α}} ( 1 - {z}_{t}^{\overline{α}} ) \leq q ( {x}_{t} ; {ω}_{\overline{α}} ) \leq {\overline{w}}_{t} + ( {w}_{c} - {\overline{w}}_{t} ) {z}_{t}^{\overline{α}} , ∀ t ∈ 𝒯$$

$${z}_{t}^{\underline{α}} + {z}_{t}^{\overline{α}} - 1 \leq {z}_{t} \leq min \{ {z}_{t}^{\underline{α}} , {z}_{t}^{\overline{α}} \} , ∀ t ∈ 𝒯$$

$${\sum }_{t ∈ 𝒯} ( 1 - {z}_{t} ) \leq ϵ \vert 𝒯 \vert$$

$$0 \leq q ( {x}_{t} ; {ω}_{\underline{α}} ) \leq q ( {x}_{t} ; {ω}_{\overline{α}} ) \leq {w}_{c} , ∀ t ∈ 𝒯$$

$$0 \leq {r}_{t}^{u} - [ {\hat{w}}_{t} - q ( {x}_{t} ; {ω}_{\underline{α}} ) ] \leq {M}_{t}^{u} ( 1 - {z}_{t}^{u} ) , ∀ t ∈ 𝒯$$

$$0 \leq {r}_{t}^{u} \leq {\hat{w}}_{t} {z}_{t}^{u} , ∀ t ∈ 𝒯$$

$$0 \leq {r}_{t}^{d} - [ q ( {x}_{t} ; {ω}_{\overline{α}} ) - {\hat{w}}_{t} ] \leq {M}_{t}^{d} ( 1 - {z}_{t}^{d} ) , ∀ t ∈ 𝒯$$

$$0 \leq {r}_{t}^{d} \leq ( {w}_{c} - {\hat{w}}_{t} ) {z}_{t}^{d} , ∀ t ∈ 𝒯$$

$${z}_{t}^{\underline{α}} , {z}_{t}^{\overline{α}} , {z}_{t} , {z}_{t}^{u} , {z}_{t}^{d} ∈ \{ 0 , 1 \} , ∀ t ∈ 𝒯$$

$${r}_{t , -}^{u} \geq {\hat{w}}_{t} - {\overline{w}}_{t} - {r}_{t}^{u} , ∀ t ∈ 𝒯$$

$${r}_{t , -}^{d} \geq {\overline{w}}_{t} - {\hat{w}}_{t} - {r}_{t}^{d} , ∀ t ∈ 𝒯$$

r_{t,—}^{u},r_{t,—}^{d}≥0, ∀t∈

[symbol]

η_{α}≥ω_{α},η_{α}≥−ω_{α}, ∀α∈{α,α̅}

in which, rₜ^{u} and rₜ^{d} are positive and negative reserve provisions respectively, r_{t,—}^{u} and t_{t,—}^{d} are positive and negative reserve deficits respectively; π^{u} and π^{d} are prices for the positive and negative reserve provision payments respectively, π_^{u} and π_^{d} are prices for the positive and negative reserve deficit penalties respectively; λ is a weight parameter of L1 regular term, whose value trade-offs between the goodness-of-fit and model complexity; \vec{1} is a vector whose elements are all 1, η_{α} and η_{α̅} are introduced auxiliary vectors whose dimensions are the same as ω_{α} and ω_{α̅}; and zₜ^{α},zₜ^{α̅},zₜ,zₜ^{u},zₜ^{d} are introduced auxiliary logical variables.

(4) Utilize a quantile regression technique to obtain predictive quantiles \hat{q}ₜ^{ϵ} and \hat{q}ₜ^{1-ϵ} at ϵ and 1−ϵ quantile proportions of the wind power w̅ₜ in training set samples, and the predictive quantiles are utilized to approximate the infimum inf{q(xₜ;ω_{α̅})} of the upper boundary of the prediction interval and supremum sup{q(xₜ;ω_{α})} of the lower boundary of the prediction interval:

sup{q(xₜ;ω_{α})}≈\hat{q}ₜ^{ϵ}, ∀t∈

[symbol]

inf{q(xₜ;ω_{α̅})}≈\hat{q}ₜ^{1-ϵ}, ∀t∈ [symbol] .

(5) Obtain big-M coefficients shrunk in a mixed integer linear programming model by the following formulas:

Mₜ^{α}=sup{q(xₜ;ω_{α})}−w̅ₜ≈\hat{q}ₜ^{ϵ}−w̅ₜ, ∀t∈

[symbol]

Mₜ^{α̅}=w̅ₜ−inf{q(xₜ;ω_{α̅})}≈w̅ₜ−\hat{q}ₜ^{1-ϵ}, ∀t∈

[symbol]

Mₜ^{u}=sup{q(xₜ;ω_{α})}−ŵₜ≈\hat{q}ₜ^{ϵ}−ŵₜ, ∀t∈

[symbol]

Mₜ^{u}=ŵₜ−inf{q(xₜ;ω_{α̅})}≈ŵₜ−\hat{q}ₜ^{1-ϵ}, ∀t∈

[symbol]

(6) Define time index sets [symbol] , [symbol] , [symbol] for auxiliary logical variable reduction. Wherein the set [symbol] contains time indexes corresponding to all the real wind power w̅ₜ covered by the interval [\hat{q}ₜ^{ϵ},\hat{q}ₜ^{1-ϵ}] in the training dataset, namely

[symbol]

:={t∈ [symbol] |\hat{q}ₜ^{ϵ}≤w̅ₜ≤\hat{q}ₜ^{1-ϵ}}.

The set [symbol] contains time indexes corresponding to all the expected wind power values ŵₜ greater than or equal to \hat{q}ₜ^{ϵ} in the training dataset, namely

[symbol]

:={t∈ [symbol] |ŵₜ−\hat{q}ₜ^{ϵ}≥0}.

The set [symbol] contains the time indexes corresponding to all the expected wind power values ŵₜ less than or equal to \hat{q}ₜ^{1-ϵ} in the training dataset, namely

[symbol]

:={t∈ [symbol] |\hat{q}ₜ^{1-ϵ}−ŵₜ≥0}.

(7) Establish a reduced mixed integer linear programming problem:

$${min}_{\begin{matrix}{ω}_{\underline{α}} , {ω}_{\overline{α}} , {η}_{\underline{α}} , {η}_{\overline{α} ,} \\ {r}_{t}^{u} , {r}_{t}^{d} , {r}_{t , -}^{u} , {r}_{t , -}^{d} , \\ {z}_{t}^{\underline{α}} , {z}_{t}^{\overline{α}} , {z}_{t} , {z}_{t}^{u} , {z}_{t}^{d}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ {\vec{1}}^{T} ( {η}_{\underline{α}} + {η}_{\overline{α}} )$$

which is subject to:

$$q ( {x}_{t} ; {ω}_{\underline{α}} ) \leq {\overline{w}}_{t} \leq q ( {x}_{t} ; {ω}_{\overline{α}} ) , ∀ t ∈ 𝒮$$

$${\overline{w}}_{t} - {\overline{w}}_{t} {z}_{t}^{\underline{α}} \leq q ( {x}_{t} ; {ω}_{\underline{α}} ) \leq {\overline{w}}_{t} + ( {\hat{q}}_{t}^{ϵ} - {\overline{w}}_{t} ) ( 1 - {z}_{t}^{\underline{α}} ) , ∀ t ∈ 𝒯 \backslash 𝒮$$

$${\overline{w}}_{t} - ( {\overline{w}}_{t} - {\hat{q}}_{t}^{1 - ϵ} ) ( 1 - {z}_{t}^{\overline{α}} ) \leq q ( {x}_{t} , {ω}_{\overline{α}} ) \leq {\overline{w}}_{t} + ( {w}_{c} - {\overline{w}}_{t} ) {z}_{t}^{\overline{α}} , ∀ t ∈ 𝒯 \backslash 𝒮$$

$${z}_{t}^{\underline{α}} + {z}_{t}^{\overline{α}} - 1 \leq {z}_{t} \leq min \{ {z}_{t}^{\underline{α}} , {z}_{t}^{\overline{α}} \} , ∀ t ∈ 𝒯 \backslash 𝒮$$

$${\sum }_{t ∈ 𝒯 \backslash 𝒮} ( 1 - {z}_{t} ) \leq ϵ \vert 𝒯 \vert$$

$$0 \leq q ( {x}_{t} ; {ω}_{\underline{α}} ) \leq q ( {x}_{t} ; {ω}_{\overline{α}} ) \leq {w}_{c} , ∀ t ∈ 𝒯$$

$${r}_{t}^{u} = {\hat{w}}_{t} - q ( {x}_{t} ; {ω}_{\underline{α}} ) , ∀ t ∈ ℒ$$

$${r}_{t}^{d} = q ( {x}_{t} ; {ω}_{\overline{α}} ) - {\hat{w}}_{t} , ∀ t ∈ 𝒰$$

$$0 \leq {r}_{t}^{u} - [ {\hat{w}}_{t} - q ( {x}_{t} ; {ω}_{\underline{α}} ) ] \leq {M}_{t}^{u} ( 1 - {z}_{t}^{u} ) , ∀ t ∈ 𝒯 \backslash ℒ$$

$$0 \leq {r}_{t}^{u} \leq {\hat{w}}_{t} {z}_{t}^{u} , ∀ t ∈ 𝒯 \backslash ℒ$$

$$0 \leq {r}_{t}^{d} - [ q ( {x}_{t} ; {ω}_{\overline{α}} ) - {\hat{w}}_{t} ] \leq {M}_{t}^{d} ( 1 - {z}_{t}^{d} ) , ∀ t ∈ 𝒯 \backslash 𝒰$$

$$0 \leq {r}_{t}^{d} \leq ( {w}_{c} - {\hat{w}}_{t} ) {z}_{t}^{d} , ∀ t ∈ 𝒯 \backslash 𝒰$$

$${z}_{t}^{\underline{α}} , {z}_{t}^{\overline{α}} , {z}_{t} , {z}_{t}^{u} , {z}_{t}^{d} ∈ \{ 0 , 1 \} , ∀ t$$

$${r}_{t , -}^{u} \geq {\hat{w}}_{t} - {\overline{w}}_{t} - r - tu , ∀ t ∈ 𝒯$$

$${r}_{t , -}^{d} \geq {\overline{w}}_{t} - {\hat{w}}_{t} - {r}_{t}^{d} , ∀ t ∈ 𝒯$$

$${r}_{t , -}^{u} , {r}_{t , -}^{d} \geq 0 , ∀ t ∈ 𝒯$$

$${η}_{α} \geq {ω}_{α} , {η}_{α} \geq - {ω}_{α} , ∀ α ∈ \{ \underline{α} , \overline{α} \}$$

(8) Utilize branch and bound algorithm to solve the mixed integer linear programming problem, obtain the optimized output weight vectors ω_{α} and ω_{α̅}, and complete training of the extreme learning machine.

(9) Utilize test dataset [symbol] :={xₜ,w̅ₜ}_{t∈ε} to obtain the lower boundary {q(xₜ,ω_{α})}_{t∈ε} and the upper boundary {q(xₜ,ω_{α̅})}_{t∈ε} of prediction intervals, and then calculate decision results of the positive and negative reserve provision and deficits thereof:

rₜ^{u}=max{ŵₜ−q(xₜ;ω_{α}),0}, ∀t∈ε

rₜ^{d}=max{q(xₜ;ω_{α̅})−ŵₜ,0}, ∀t∈ε

r_{t,—}^{u}=max{ŵₜ−w̅ₜ−rₜ^{u},0}, ∀t∈ε

r_{t,—}^{d}=max{w̅ₜ−ŵₜ−rₜ^{d},0}, ∀t∈ε

in which, max{•} is a maximum value function, which returns the largest operand.

(10) Evaluate reliability of the reserve quantification according to confidence margin (CM), which is defined as a difference value between the empirical probability of prediction errors covered by reserves and the nominal reliability level 100(1−ϵ)%:

$$CM := \frac{1}{\vert ε \vert} {\sum }_{t ∈ 𝒮} 𝕀 ( - {r}_{t}^{d} \leq {\hat{w}}_{t} - {\overline{w}}_{t} \leq {r}_{t}^{u} ) - 100 ( 1 - ϵ ) \%$$

in which, [symbol] (•), is an indicator function, and the function value is 1 when the logical expression in the parentheses is true, otherwise the function value is 0. The higher the confidence margin CM is, the better the reliability of the reserve quantification is.

The operational cost C_{ε} of operating reserve can be estimated by the sum of the reserve provision payment and the reserve deficit penalty:

$${C}_{ε} = {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) .$$

Obviously, the reserve C_{ε} quantification should achieve the lowest possible operation cost on the premise of well reliability.

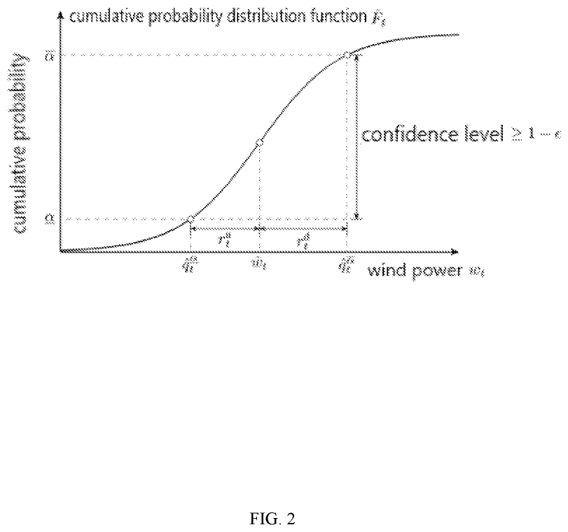

FIG. 2 shows a relation among the prediction interval composed of predictive wind power quantiles (\hat{q}ₜ^{α} and \hat{q}ₜ^{α̅}), the expected wind power value (ŵₜ) and the positive and negative operating reserve (rₜ^{u} and rₜ^{d}). As can be seen from this figure, the positive reserve rₜ^{u} of the system can be expressed as a difference between the expected wind power ŵₜ and the lower boundary \hat{q}ₜ^{α} of the prediction interval, and the negative reserve rₜ^{d} can be expressed as a difference between the upper boundary \hat{q}ₜ^{α̅} of the prediction interval and the expected wind power value ŵₜ.

The specific embodiments of the present invention have been described above in conjunction with the accompanying drawings, which are not intended to limit the protection scope of the present invention. All equivalent models or equivalent algorithm flows made using the contents of the description and accompanying drawings of the present invention can be directly or indirectly applied to other related technical fields, and are all within the patent protection scope of the present invention.

What is claimed is:

1. An operating reserve quantification method for power systems using probabilistic wind power forecasting, the method comprising, without setting confidence level of prediction intervals and boundary quantile proportions in advance, defining a lowest confidence of the prediction intervals with respect to training samples by an inequation constraint, directly outputting the prediction intervals of wind power by extreme learning machine, determining capacity requirements of positive and negative operating reserve of the system based on boundaries of the prediction intervals, and by taking backup reserve cost and backup deficit penalty as a loss function, constructing an operating reserve optimization model of power systems using probabilistic wind power forecasting:
$${min}_{\begin{matrix}{ω}_{\underline{α}} , {ω}_{\overline{α}} , \\ \begin{matrix}{r}_{t}^{u} , {r}_{t}^{d} , \\ {r}_{t , -}^{u} , {r}_{t , -}^{d}\end{matrix}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ ( {‖ {ω}_{\underline{α}} ‖}_{1} + {‖ {ω}_{\overline{α}} ‖}_{1} )$$
which is subject to:
$$\frac{1}{𝒯} {\sum }_{t ∈ 𝒯} 𝕀 ( q ( {x}_{t} ; {ω}_{\underline{α}} ) \leq {\overline{w}}_{t} \leq q ( {x}_{t} ; {ω}_{\overline{α}} ) ) \geq 1 - ϵ$$
$$0 \leq q ( {x}_{t} ; {ω}_{\underline{α}} ) \leq q ( {x}_{t} ; {ω}_{\overline{α}} ) \leq {w}_{c} , ∀ t ∈ 𝒯$$
$${r}_{t}^{u} = max \{ {\hat{w}}_{t} - q ( {x}_{t} ; {ω}_{\underline{α}} ) , 0 \} , ∀ t ∈ 𝒯$$
$${r}_{t}^{d} = max \{ q ( {x}_{t} ; {ω}_{\overline{α}} ) - {\hat{w}}_{t} , 0 \} , ∀ t ∈ 𝒯$$
$${r}_{t , -}^{u} = max \{ {\hat{w}}_{t} - {\overline{w}}_{t} - {r}_{t}^{u} , 0 \} , ∀ t ∈ 𝒯$$
$${r}_{t , -}^{d} = max \{ {\overline{w}}_{t} - {\hat{w}}_{t} - {r}_{t}^{d} , 0 \} , ∀ t ∈ 𝒯$$
in which t is a time index, [symbol] is a time index set of the training samples; ω_{α} and ω_{α̅} are weight vectors corresponding to two output neurons in the extreme learning machine; rₜ^{u} and rₜ^{d} are positive and negative reserve capacities respectively, r_{t,—}^{u} and r_{t,—}^{d} are positive and negative reserve deficits respectively; π^{u} and π^{d} are prices for the positive and negative reserve provision payments respectively, π_^{u} and π_^{d} are prices for the positive and negative reserve deficit penalties respectively; λ is a weight parameter of L1 regular term (∥ω_{α}∥₁+∥ω_{α̅}∥₁), whose value trade-offs between the goodness-of-fit and model complexity; w̅ₜ is real wind power, ŵₜ is expected wind power, w_{c} is the total quantity of wind power installations of the system; q(xₜ;ω_{α̅}) and q(xₜ;ω_{α}) are upper and lower boundaries of the prediction interval output by the extreme learning machine; xₜ is an input feature vector of a machine learning model; 1−ϵ is a lowest confidence level of the prediction interval, which corresponds to reliability requirement of operating reserve of the power system; [symbol] (•) is an indicator function, and a function value is 1 when a logical expression in the parentheses is established, otherwise the function value is 0; and max{•} is a maximum value function, which returns a largest operand;
wherein the operating reserve optimization model of power systems using probabilistic wind power forecasting linearizes a non-smooth L1 regular term in the loss function by introducing auxiliary continuous vectors, linearizes the indicator function and the maximum value function in constraints by introducing auxiliary logical variables, and transforms equivalently a quantization model of operating reserve based on probabilistic forecasting of wind power into a mixed integer linear programming problem:
$${min}_{\begin{matrix}{ω}_{\underline{α}} , {ω}_{\overline{α}} , {η}_{\underline{α}} , {η}_{\overline{α ,}} \\ \begin{matrix}{r}_{t}^{u} , {r}_{t}^{d} , {r}_{t , -}^{u} , {r}_{t , -}^{d} , \\ {z}_{t}^{\underline{α}} , {z}_{t}^{\overline{α}} , {z}_{t} {z}_{t}^{u} , {z}_{t}^{d}\end{matrix}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ {\vec{1}}^{T} ( {η}_{\underline{α}} + {η}_{\overline{α}} )$$
which is subject to:
$${\overline{w}}_{t} - {\overline{w}}_{t} {z}_{t}^{\underline{α}} \leq q ( {x}_{t} ; {ω}_{\underline{α}} ) \leq {\overline{w}}_{t} + {M}_{t}^{\underline{α}} ( 1 - {z}_{t}^{\underline{α}} ) , ∀ t ∈ 𝒯$$
$${\overline{w}}_{t} - {M}_{t}^{\overline{α}} ( 1 - {z}_{t}^{\overline{α}} ) \leq q ( {x}_{t} ; {ω}_{\overline{α}} ) \leq {\overline{w}}_{t} + ( {w}_{c} - {\overline{w}}_{t} ) {z}_{t}^{\overline{α}} , ∀ t ∈ 𝒯$$
$${z}_{t}^{\underline{α}} + {z}_{t}^{\overline{α}} - 1 \leq {z}_{t} \leq min \{ {z}_{t}^{\underline{α}} , {z}_{t}^{\overline{α}} \} , ∀ t ∈ 𝒯$$
$${\sum }_{t ∈ 𝒯} ( 1 - {z}_{t} ) \leq ϵ \vert 𝒯 \vert$$
$$0 \leq q ( {x}_{t} ; {ω}_{\underline{α}} ) \leq q ( {x}_{t} ; {ω}_{\overline{α}} ) \leq {w}_{c} , ∀ t ∈ 𝒯$$
$$0 \leq {r}_{t}^{u} - [ {\hat{w}}_{t} - q ( {x}_{t} , {ω}_{\underline{α}} ) ] \leq {M}_{t}^{u} ( 1 - {z}_{t}^{u} ) , ∀ t ∈ 𝒯$$
$$0 \leq {r}_{t}^{u} \leq {\hat{w}}_{t} {z}_{t}^{u} , ∀ t ∈ 𝒯$$
$$0 \leq {r}_{t}^{d} - [ q ( {x}_{t} ; {ω}_{\overline{α}} ) - {\hat{w}}_{t} ] \leq {M}_{t}^{d} ( 1 - {z}_{t}^{d} ) , ∀ t ∈ 𝒯$$
$$0 \leq {r}_{t}^{d} \leq ( {w}_{c} - {\hat{w}}_{t} ) {z}_{t}^{d} , ∀ t ∈ 𝒯$$
$${z}_{t}^{\underline{α}} , {z}_{t}^{\overline{α}} , {z}_{t} , {z}_{t}^{u} , {z}_{t}^{d} ∈ \{ 0 , 1 \} , ∀ t ∈ 𝒯$$
r_{t,—}^{u}≥ŵₜ−w̅ₜ−rₜ^{u}, ∀t∈ [symbol]
r_{t,—}^{d}≥w̅ₜ−ŵₜrₜ^{d}, ∀t∈ [symbol]
r_{t,—}^{u},r_{t,—}^{d}≥0, ∀t∈ [symbol]
η_{α}≥ω_{α},η_{α}≥−ω_{α}, ∀α∈{α,α̅}
in which \vec{1} is a vector whose elements are all 1, η_{α} and η_{α̅} are the introduced auxiliary vectors equal to the elementwise absolute value of ω_{α} and ω_{α̅} at the optimal solution of above optimization problem; zₜ^{α},zₜ^{α̅},zₜ,zₜ^{u},zₜ^{d} are the introduced auxiliary logical variables, wherein zₜ^{α},zₜ^{α̅},zₜ linearize inequality constraint including the indicator function, zₜ^{u};zₜ^{d} linearize equality constraints including the maximum value function; Mₜ^{α}, Mₜ^{α̅}, Mₜ^{u}, Mₜ^{d} are referred to as the big-M coefficients, Mₜ^{α} is a constant coefficient larger than q(xₜ;ω_{α})−w̅ₜ, Mₜ^{α̅} is a constant coefficient larger than w̅ₜ−q(xₜ;ω_{α̅}), Mₜ^{u} is a constant coefficient larger than q(xₜ;ω_{α})−ŵₜ, and Mₜ^{d} is a constant coefficient larger than ŵₜ−q(xₜ;ω_{α̅});
wherein the mixed integer linear programming problem achieves feasible region tightening of the mixed integer linear programming problem by shrinking the big-M coefficients:
Mₜ^{α}=sup{q(xₜ;ω_{α})}−w̅ₜ≈\hat{q}ₜ^{ϵ}−w̅ₜ, ∀t∈ [symbol]
Mₜ^{α̅}=w̅ₜ−inf{q(xₜ;ω_{α̅})}≈w̅ₜ−\hat{q}ₜ^{1-ϵ}, ∀t∈ [symbol]
Mₜ^{u}=sup{q(xₜ;ω_{α})}−ŵₜ≈\hat{q}ₜ^{ϵ}−ŵₜ, ∀t∈ [symbol]
Mₜ^{u}=ŵₜ−inf{q(xₜ;ω_{α̅})}≈ŵₜ−\hat{q}ₜ^{1-ϵ}, ∀t∈ [symbol]
in which, sup{•} and int{•} are operators of supremum and infimum respectively; \hat{q}ₜ^{ϵ} and \hat{q}ₜ^{1-ϵ} indicate predictive quantiles at quantile proportions of ϵ and 1−ϵ respectively, \hat{q}ₜ^{ϵ} and \hat{q}ₜ^{1-ϵ} are an upper estimation of the lower boundary q(xₜ;ω_{α}) and a lower estimation of the upper boundary q(xₜ;ω_{α̅}) of the prediction interval respectively;
wherein the mixed integer linear programming problem is reformulated as a reduced mixed integer linear programming problem by executing a feasible region tightening strategy in which the big-M coefficients are shrunk and the auxiliary logical variables are partly eliminated:
$${min}_{\begin{matrix}{ω}_{\underline{α}} , {ω}_{\overline{α}} , {η}_{\underline{α}} , {η}_{\overline{α ,}} \\ \begin{matrix}{r}_{t}^{u} , {r}_{t}^{d} , {r}_{t , -}^{u} , {r}_{t , -}^{d} , \\ {z}_{t}^{\underline{α}} , {z}_{t}^{\overline{α}} , {z}_{t} , {z}_{t}^{u} , {z}_{t}^{d}\end{matrix}\end{matrix}} {\sum }_{t ∈ 𝒯} ( {π}^{u} {r}_{t}^{u} + {π}^{d} {r}_{t}^{d} + {π}_{-}^{u} {r}_{t , -}^{u} + {π}_{-}^{d} {r}_{t , -}^{d} ) + λ {\vec{1}}^{T} ( {η}_{\underline{α}} + {η}_{\overline{α}} )$$
which is subject to:
$$q ( {x}_{t} ; {ω}_{\underline{α}} ) \leq {\overline{w}}_{t} \leq q ( {x}_{t} , {ω}_{\overline{α}} ) , ∀ t ∈ 𝒮$$
$${\overline{w}}_{t} - {\overline{w}}_{t} {z}_{t}^{\underline{α}} \leq q ( {x}_{t} ; {ω}_{\underline{α}} ) \leq {\overline{w}}_{t} + ( {\hat{q}}_{t}^{ϵ} - {\overline{w}}_{t} ) ( 1 - {z}_{t}^{\underline{α}} ) , ∀ t ∈ 𝒯 \backslash 𝒮$$
$${\overline{w}}_{t} - ( {\overline{w}}_{t} - {\hat{q}}_{t}^{1 - ϵ} ) ( 1 - {z}_{t}^{\overline{α}} ) \leq q ( {x}_{t} ; {ω}_{\overline{α}} ) \leq {\overline{w}}_{t} + ( {w}_{c} - {\overline{w}}_{t} ) {z}_{t}^{\overline{α}} , ∀ t ∈ 𝒯 \backslash 𝒮$$
$${z}_{t}^{\underline{α}} + {z}_{t}^{\overline{α}} - 1 \leq {z}_{t} \leq min \{ {z}_{t}^{\underline{α}} , {z}_{t}^{\overline{α}} \} , ∀ t ∈ 𝒯 \backslash 𝒮$$
$${\sum }_{t ∈ 𝒯 \backslash 𝒮} ( 1 - {z}_{t} ) \leq ϵ \vert 𝒯 \vert$$
$$0 \leq q ( {x}_{t} ; {ω}_{\underline{α}} ) \leq q ( {x}_{t} ; {ω}_{\overline{α}} ) \leq {w}_{c} , ∀ t ∈ 𝒯$$
$${r}_{t}^{u} = {\hat{w}}_{t} - q ( {x}_{t} ; {ω}_{\underline{α}} ) , ∀ t ∈ ℒ$$
$${r}_{t}^{d} = q ( {x}_{t} ; {ω}_{\overline{α}} ) - {\hat{w}}_{t} , ∀ t ∈ 𝒰$$
$$0 \leq {r}_{t}^{u} - [ {\hat{w}}_{t} - q ( {x}_{t} ; {ω}_{\underline{α}} ) ] \leq {M}_{t}^{u} ( 1 - {z}_{t}^{u} ) , ∀ t ∈ 𝒯 \backslash ℒ$$
$$0 \leq {r}_{t}^{u} \leq {\hat{w}}_{t} {z}_{t}^{u} , ∀ t ∈ 𝒯 \backslash ℒ$$
$$0 \leq {r}_{t}^{d} - [ q ( {x}_{t} ; {ω}_{\overline{α}} ) - {\hat{w}}_{t} ] \leq {M}_{t}^{d} ( 1 - {z}_{t}^{d} ) , ∀ t ∈ 𝒯 \backslash 𝒰$$
$$0 \leq {r}_{t}^{d} \leq ( {w}_{c} - {\hat{w}}_{t} ) {z}_{t}^{d} , ∀ t ∈ 𝒯 \backslash 𝒰$$
$${z}_{t}^{\underline{α}} , {z}_{t}^{\overline{α}} , {z}_{t} , {z}_{t}^{u} , {z}_{t}^{d} ∈ \{ 0 , 1 \} , ∀ t$$
$${r}_{t , -}^{u} \geq {\hat{w}}_{t} - {\overline{w}}_{t} - {r}_{t}^{u} , ∀ t ∈ 𝒯$$
$${r}_{t , -}^{d} \geq {\overline{w}}_{t} - {\hat{w}}_{t} - {r}_{t}^{d} , ∀ t ∈ 𝒯$$
$${r}_{t , -}^{u} , {r}_{t , -}^{d} \geq 0 , ∀ t ∈ 𝒯$$
$${η}_{α} \geq {ω}_{α} , {η}_{α} \geq - {ω}_{α} , ∀ α ∈ \{ \underline{α} , \overline{α} \}$$
in which, \ is a difference set symbol.

2. The method of claim 1, wherein, the mixed integer linear programming problem achieves the feasible region tightening of the mixed integer linear programming problem by reducing the auxiliary logical variables:
zₜ^{α}=zₜ^{α̅}=zₜ=1, ∀t∈ [symbol]
zₜ^{u}=1, ∀t∈ [symbol]
zₜ^{d}=1, ∀t∈ [symbol]
in which, a set [symbol] contains time indexes corresponding to all the real wind power w̅ₜ, covered by an interval [\hat{q}ₜ^{e},\hat{q}ₜ^{1-e}] in training dataset, namely [symbol]
:={t∈ [symbol] |\hat{q}ₜ^{e}≤w̅ₜ≤\hat{q}ₜ^{1-e}}
a set [symbol] contains time indexes corresponding to all the expected wind power ŵₜ greater than or equal to \hat{q}ₜ^{e} in the training dataset, namely [symbol]
:={t∈ [symbol] |ŵₜ−\hat{q}ₜ^{e}≥0}
a set [symbol] contains time indexes corresponding to all the expected wind power ŵₜ less than or equal to \hat{q}ₜ^{1-e} in the training dataset, namely [symbol]
:={t∈ [symbol] |\hat{q}ₜ^{1-e}−ŵₜ≥0}
the logical variables zₜ,zₜ^{u},zₜ^{d} whose time indexes in the sets [symbol] , [symbol] , [symbol] respectively, certainly have values of 1, and can be preset in advance before solving the optimization problem, thereby achieving reduction of the auxiliary logical variables.

3. The method of claim 1, wherein,
the reduced mixed integer linear programming problem is solved by branch and bound algorithm, thereby achieving training of the machine learning model.
